(19) United States
(12) Patent Application Publication
(10) Pub. No.: US 2012/0111523 A1
(43) Pub. Date: May 10, 2012

(54) MELTING UNIT FOR A DIE CASTING SYSTEM

(76) Inventors: Mario P. Bochiechio, Vernon, CT (US); John Joseph Marcin, Marlborough, CT (US); Carl R. Verner, Windsor, CT (US); Steven J. Bullied, Pomfret Center, CT (US)

(21) Appl. No.: 12/940,080

(22) Filed: Nov. 5, 2010

(51) Int. Cl. B22D 17/04; C21C 5/42; H05B 6/36; B22D 27/11

(52) U.S. Cl. 164/113; 164/316; 266/236; 219/672

(57) ABSTRACT

A die casting system includes a die, a shot tube, a shot tube plunger and a melting unit. The die includes a plurality of die components that define a die cavity. The shot tube is in fluid communication with the die cavity. A shot tube plunger is moveable within the shot tube to communicate a charge of material into the die cavity. The melting unit is positioned relative to the die and includes a bottom portion having an opening for selectively releasing a charge of material through the bottom portion.

### BACKGROUND

This disclosure relates generally to die casting systems, and more particularly to a melting unit for a die casting system.

Casting is a known technique used to yield near net-shaped components. For example, investment casting is often used in the gas turbine engine industry to manufacture near net-shaped components, such as blades and vanes having relatively complex geometries. Investment casting involves pouring molten metal into a ceramic shell having a cavity in the shape of the component to be cast. Generally, the shape of the component to be produced is derived from a wax pattern or SLA pattern to form the exterior shape of the component. The investment casting process is capital intensive, requires significant manual labor, and can be time intensive to produce the final component.

Die casting is another known casting technique. Die casting involves injecting molten metal directly into a reusable die to yield a near net-shaped component. Die casting has typically been used to produce components that do not require high thermal mechanical performance. For example, die casting is commonly used to cast components made from relatively low melting temperature metals, including aluminum, zinc, magnesium, and copper. The current products manufactured from these alloy systems are not generally exposed to extreme operating conditions. Die casting has not traditionally been effective in casting components made from high melting temperature materials. The ineffectiveness of known die casting systems is at least partially attributable to the inability of the die casting components, such as the shot tube, shot tube plunger and die, to withstand thermal mechanical fatigue that can occur during the injection of high melting temperature materials.

### SUMMARY

An exemplary die casting system includes a die, a shot tube, a shot tube plunger and a melting unit. The die includes a plurality of die components that define a die cavity. The shot tube is in fluid communication with the die cavity. A shot tube plunger is moveable within the shot tube to communicate a charge of material into the die cavity. The melting unit is positioned relative to the die and includes a bottom portion having an opening for selectively releasing a charge of material through the bottom portion.

In another exemplary embodiment, a method of die casting a component includes melting a charge of material inside a melting unit of a die casting system, releasing the charge of material through an opening disposed in a bottom portion of the melting unit into the die casting system, and injecting the charge of material into a die cavity of the die to cast the component.

In yet another exemplary embodiment, a melting unit for a die casting system includes a top portion, a bottom portion and a body that extends between the top portion and the bottom portion. An opening extends through the bottom portion. A closure member is positioned relative to the opening and is selectively moveable between a first position and a second position to uncover the opening and release a charge of material through the bottom portion.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 illustrates an example die casting system.

FIG. 2 illustrates an example melting unit for use with a die casting system.

FIG. 3 illustrates an example closure member of the melting unit of FIG. 2.

FIG. 4 illustrates another example melting unit.

FIG. 5 illustrates an example feed configuration of a die casting system.

FIG. 6 illustrates another example feed configuration of a die casting system.

### DETAILED DESCRIPTION

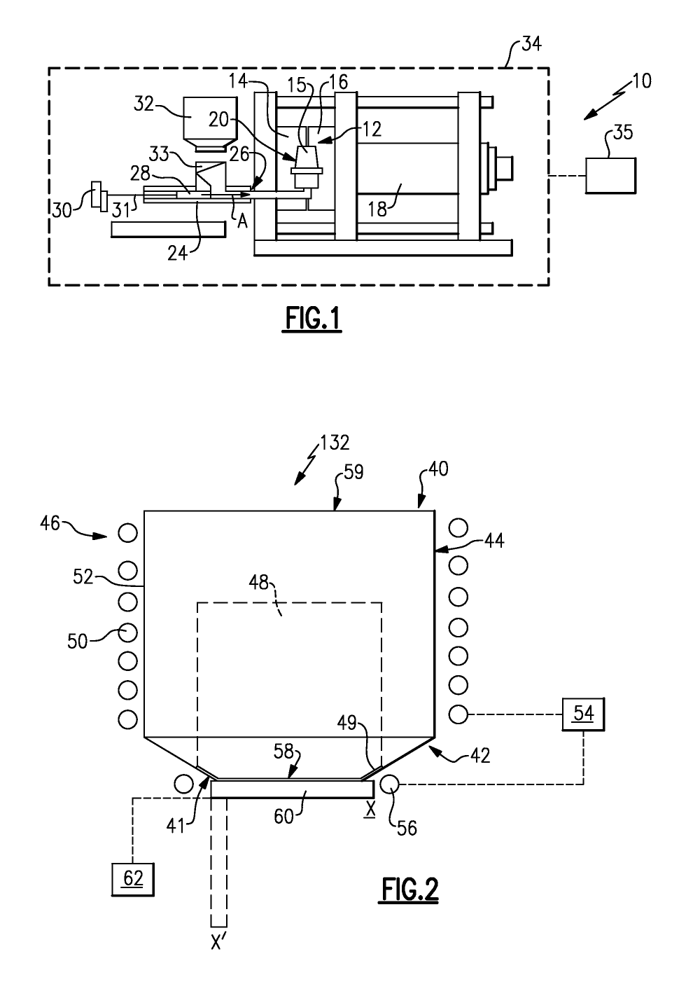

FIG. 1 illustrates a die casting system 10 including a reusable die 12 having a plurality of die elements 14, 16 that function to cast a component 15. The component 15 could include aeronautical components, such as a gas turbine engine blade or vane, or non-aeronautical components. Although two die elements 14, 16 are depicted by FIG. 1, it should be understood that the die 12 could include more or fewer die elements, as well as other parts and other configurations.

The die 12 is assembled by positioning the die elements 14, 16 together and holding the die elements 14, 16 at a desired position via a mechanism 18. The mechanism 18 could include a clamping mechanism of appropriate hydraulic, pneumatic, electromechanical, and/or other configurations. The mechanism 18 also separates the die elements 14, 16 subsequent to casting.

The die elements 14, 16 include internal surfaces that cooperate to define a die cavity 20. A shot tube 24 is in fluid communication with the die cavity 20 via one or more ports 26 that extend into the die element 14, the die element 16 or both. A shot tube plunger 28 is received within the shot tube 24 and is moveable between a retracted and injected position (in the direction of arrow A) within the shot tube 24 by a mechanism 30. A shaft 31 extends between the mechanism 30 and the shot tube plunger 28. The mechanism 30 could include a hydraulic assembly or other suitable system, including, but not limited to, pneumatic, electromechanical, hydraulic or any combination of systems.

The shot tube 24 is positioned to receive a charge of material from a melting unit 32, such as a crucible, for example. The melting unit 32 may utilize any known technique for melting an ingot of metallic material to prepare molten metal for delivery to the shot tube 24, such as will be further discussed below. In this example, the charge of material is melted into molten metal by the melting unit 32 at a location that is separate from the shot tube 24 and the die 12. However, other melting configurations are contemplated as within the scope of this disclosure. The example melting unit 32 is positioned in relative close proximity to the die casting system 10 to reduce the transfer distance of the charge of material between the melting unit 32 and the die casting system 10.

Materials used to die cast a component 15 with the die casting system 10 include, but are not limited to, nickel-based super alloys, cobalt-based super alloys, titanium alloys, high temperature aluminum alloys, copper-based alloys, iron alloys, molybdenum, tungsten, niobium or other refractory metals. This disclosure is not limited to the disclosed alloys, and other high melting temperature materials may be utilized to die cast a component 15. As used in this disclosure, the term “high melting temperature material” is intended to include materials having a melting temperature of approximately 1500° F./815° C. and higher.

The charge of material is transferred from the melting unit 32 to the die casting system 10. For example, the charge of material may be poured into a pour hole 33 of the shot tube 24. A sufficient amount of molten metal is poured into the shot tube to fill the die cavity 20. The shot tube plunger 28 is actuated to inject the charge of material under pressure from the shot tube 24 into the die cavity 20 to cast the component 15. Although the casting of a single component is depicted, the die casting system 10 could be configured to cast multiple components in a single shot.

Although not necessary, at least a portion of the die casting system 10 can be positioned within a vacuum chamber 34 that includes a vacuum source 35. A vacuum is applied in the vacuum chamber 34 via the vacuum source 35 to render a vacuum die casting process. The vacuum chamber 34 provides a non-reactive environment for the die casting system 10 that reduces reaction, contamination or other conditions that could detrimentally affect the quality of the die casted component, such as excess porosity of the die casted component that can occur from exposure to air. In one example, the vacuum chamber 34 is maintained at a pressure between 1×10⁻³ Ton and 1×10⁻⁴ Torr, although other pressures are contemplated. The actual pressure of the vacuum chamber 34 will vary based upon the type of component 15 or alloy being cast, among other conditions and factors. In the illustrated example, each of the melting unit 32, the shot tube 24 and the die 12 are positioned within the vacuum chamber 34 during the die casting process such that the melting, injecting and solidifying of the high melting temperature material are all performed under vacuum. In another example, the vacuum chamber 34 is backfilled with an inert gas, such as Argon, for example.

The example die casting system 10 of FIG. 1 is illustrative only and could include more or fewer sections, parts and/or components. This disclosure extends to all forms of die casting, including but not limited to, horizontal, inclined or vertical die casting systems and other die casting configurations.

FIG. 2 illustrates an example melting unit 132 for use with a die casting system, such as the die casting system 10. In this disclosure, like reference numerals signify like features, and reference numerals identified in multiples of 100 signify slightly modified features. Moreover, selected features of one example embodiment may be combined with selected features of other example embodiments within the scope of this disclosure.

The melting unit 132 includes a top portion 40, a bottom portion 42 opposite from the top portion 40 and a body 44 that extends between the top portion 40 and the bottom portion 42. The melting unit 132 could include a variety of shapes, sizes and/or configurations within the scope of this disclosure and is not limited to the size and shape shown in FIG. 2.

The melting unit 132 includes a heating system 46 configured to heat a charge of material 48 inside of the melting unit 132 to prepare molten metal for delivery to a die casting system such as the die casting system 10. In this example, the heating system 46 includes a first induction coil 50 mounted about the body 44 of the melting unit 132. The first induction coil 50 is positioned in a known manner (such as with ceramic mud, slurry or cement, for example) to circumferentially coil about an exterior surface 52 of the body 44 of the melting unit 132. The first induction coil 50 of the heating system 46 induces a current inside the body 44 of the melting unit 132 to melt and/or superheat the charge of material 48. The first induction coil 50 is powered by a power source 54 in a known manner.

The heating system 46 of the melting unit 132 can also include a secondary induction coil 56. In this example, the secondary induction coil 56 is circumferentially disposed about the bottom portion 42 of the melting unit 132. The secondary induction coil 56 may be necessary to melt a portion of the charge of material 48 that solidifies at the bottom of the melting unit 132. For instance, should a skull 49 develop between a bottom-most surface 41 of the bottom portion 42 and the charge of material 48, the secondary induction coil 56 induces a current within the bottom portion 42 to re-melt the skull 49. The secondary induction coil 56 may be powered by the power source 54, or by its own separate power source. In another example, the first induction coil 50 and the secondary induction coil 56 are resistance heating elements.

The bottom portion 42 of the melting unit 132 includes an opening 58 for communicating the charge of material 48 into the die casting system 10. The opening 58 extends through the bottom-most surface 41 of the bottom portion 42. In other words, the example melting unit 132 is a bottom-pouring melting unit.

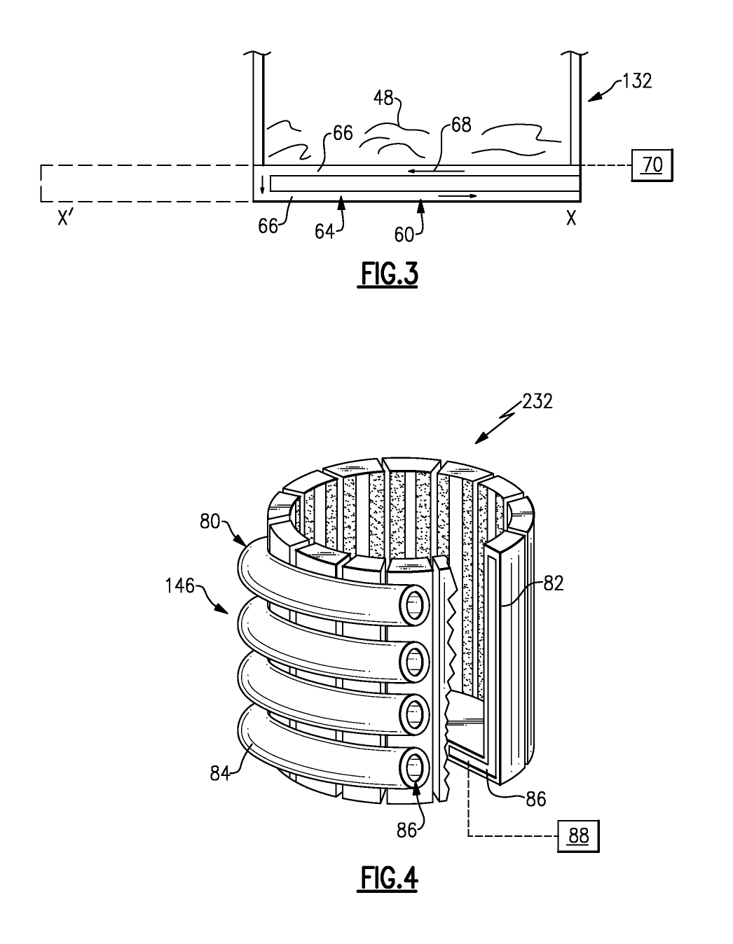

A closure member 60 is positioned relative to the melting unit 132 to selectively close the opening 58. The closure member 60 is selectively moveable between a first position X (shown in solid lines) and a second position X′ (shown in phantom lines) to uncover the opening 58. The closure member may contain features to positively lock the closure member 60 in place at the bottom of the melting unit 132 as necessary to maintain a good fit during the melting process. In this example, the first position X is a closed position and the second position X′ is an open position. In the first position, a closure member 60 covers the opening 58 to prevent the charge of material 48 from exiting the melting unit 132. In the second position X′, the closure member 60 is pivoted (See FIG. 2), axially translated (See FIG. 3), or moved in some manner to uncover the opening 58 and communicate the charge of material 48 from the melting unit 132 into the die casting system 10.

An actuator 62 can be used to selectively move the closure member 60 between the first position X and the second position X′ relative to the opening 58. However, the closure member 60 can also be manually moved between the first position X and the second position X′. The actuator 62 includes any appropriate mechanical, pneumatic, hydraulic or other system operable to move the closure member 60. The actuator 62 can also be cooled, such as water cooled, as necessary to ensure that a proper thermal gradient is maintained within the system. The closure member 60 is moveable to any position between the first position X and the second position X′ to control the rate at which the charge of material 48 is communicated through the opening 58. For example, the closure member 60 can be positioned to only partially cover the opening 58 and reduce the rate at which the charge of material 48 is poured from the melting unit 132.

The charge of material 48 may be positioned inside of the melting unit 132 in a variety of ways. For example, the charge of material 48 can be loaded through the opening 58 of the bottom portion 42. In another example, the top portion 40 includes an opening 59 for loading the charge of material 48.

FIG. 3 illustrates example features of the closure member 60 of the melting unit 132. In this example, the closure member 60 is a moveable door. Although a door is depicted, other closure members, including but not limited to ball valves, plugs and other mechanisms, are contemplated as within the scope of this disclosure. The closure member 60 includes a cooled chill door 64. The cooled chill door 64 includes cooling channels 66 that receive a coolant 68, such as water, from a coolant source 70. The coolant 68 is circulated through the cooling channels 66 to remove heat from the closure member 60 caused by direct contact with the relatively hot charge of material 48.

FIG. 4 illustrates portions of another example melting unit 232 for use with a die casting system. The melting unit 232 is substantially similar to the melting unit 132 of FIG. 2. However, the example melting unit 232 includes a slightly modified heating system 146. In this example, the heating system 146 includes an induction skull melting system 80. That is, the induction skull melting system 80 replaces the first induction coil 50 of the heating system 46 of the melting unit 132 of FIG. 2.

The induction skull melting system 80 includes wall segments 82 that are surrounded by an induction coil 84. In this example, the wall segments 82 include copper wall segments. The wall segments 82 and the induction coil 84 include cooling chambers 86 that receive a coolant, such as water, from a coolant source 88 to cool the wall segments 82 during contact with a charge of material. A magnetic field is induced by the induction coil 84 and passes through the wall segments 82 to melt the charge of material. The charge of material is loaded into and released from the melting unit 232 in a similar manner as that described above with respect to the melting unit 132. The induction skull melting system 80 can be positioned under vacuum, can be positioned in an inert protective atmosphere or can be positioned in atmospheric gases.

Other heating systems may be used with melting units of this disclosure. For example, the melting unit could include a levitation melting unit that utilizes a cold walled technique or the use of induction coils to maintain the melt in a suspended state. The levitation melting unit can be positioned under vacuum, can be positioned in an inert protective atmosphere or can be positioned in atmospheric gases. In addition, the melting unit could utilize electron beam melting, induction melting, resistance melting, a laser, or other techniques for heating a charge of material. Each of these heating systems could be positioned under vacuum, in an inert protective atmosphere, in atmospheric gases, as well as in other suitable environmental parameters.

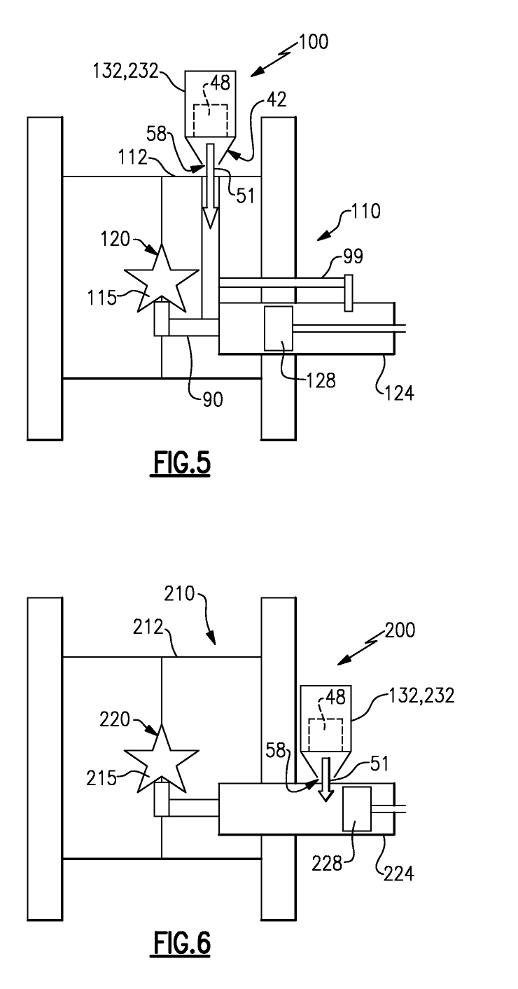

FIG. 5 illustrates a first feed configuration 100 of a die casting system 110. The feed configuration 100 can utilize either the melting unit 132 or the melting unit 232 to melt a charge of material 48 into molten metal 51. In this example, the melting unit 132, 232 is positioned directly adjacent (in this example, above) a die 112 and communicates the molten metal 51 through the opening 58 in the bottom portion 42 directly into the die 112 of the die casting system 110. A gating system 90 communicates the molten metal 51 through a die 112 and into a die cavity 120. A shut-off pin 99 controls the flow of the molten metal 51 into the die cavity 120. A shot tube 124 and a shot tube plunger 128 inject the molten metal 51 under pressure into the die cavity 120 to cast a component 115. Therefore, as is depicted in FIG. 5, the first feed configuration 100 illustrates one possible bottom feed scenario.

FIG. 6 illustrates a second example feed configuration 200 of a die casting system 210. The second feed configuration 200 can also utilize either the melting unit 132 or the melting unit 232 to melt a charge of material 48 into molten metal 51. In this example, the melting unit 132, 232 is positioned directly adjacent (in this example, above) the shot tube 224.

The example feed configuration 200 communicates the charge of material 48 through the opening 58 of the melting unit 132, 232 and into a shot tube 224 of the die casting system 210. A shot tube plunger 228 is communicated within the shot tube 224 to inject the molten metal 51 under pressure into a die cavity 220 of a die 212 to cast a component 215. The second feed configuration 200 illustrates another possible bottom feed scenario.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

1. A die casting system, comprising:
a die including a plurality of die components that define a die cavity;
a shot tube in fluid communication with said die cavity;
a shot tube plunger moveable within said shot tube to communicate a charge of material into said die cavity;
a melting unit positioned relative to said die, wherein said melting unit includes a bottom portion having an opening for selectively releasing said charge of material through said bottom portion; and
a vacuum chamber that applies a vacuum to render a vacuum die casting process, wherein at least a portion of said die is positioned within said vacuum chamber.

2. The system as recited in claim 1, wherein said melting unit includes a top portion opposite from said bottom portion and a body that extends between said top portion and said bottom portion.

3. The system as recited in claim 1, comprising a heating system disposed about said melting unit.

4. The system as recited in claim 3, wherein said heating system includes an induction skull melting system.

5. The system as recited in claim 3, wherein said heating system includes an induction melting system.

6. The system as recited in claim 3, wherein said heating system includes a resistance melting system.

7. The system as recited in claim 3, wherein said heating system includes an electron beam melting system.

8. The system as recited in claim 3, wherein said heating system includes a levitation melting system.

9. The system as recited in claim 3, wherein said heating system includes a first induction coil disposed about an outer surface of a body of said melting unit.

10. The system as recited in claim 9, wherein said heating system includes a secondary coil disposed about said bottom portion of said melting unit.

11. The system as recited in claim 9, wherein said heating system includes a resistance element disposed about said bottom portion of said melting unit.

12. The system as recited in claim 3, wherein said heating system includes resistance heating elements disposed about an outer surface of a body of said melting unit.

13. The system as recited in claim 3, wherein said heating system includes a laser positioned to melt said charge of material.

14. The system as recited in claim 1, comprising a closure member positioned relative to said opening.

15. The system as recited in claim 14, wherein said closure member includes a door that is selectively moveable between a first position and a second position to uncover said opening and release said charge of material.

16. The system as recited in claim 14, wherein said closure member includes a cooled chill door.

17. The system as recited in claim 15, wherein said door is pivoted between said first position and said second position.

18. The system as recited in claim 15, wherein said door is axially translated between said first position and said second position.

19. The system as recited in claim 1, wherein said charge of material is released through said opening of a bottom-most surface of said bottom portion into one of said die and said shot tube.

20. A method of die casting a component with a die casting system having a die, a shot tube and a melting unit, comprising the steps of:
(a) melting a charge of material inside the melting unit of the die casting system;
(b) releasing the charge of material through an opening disposed in a bottom portion of the melting unit into the die casting system;
(c) injecting the charge of material into a die cavity of the die to cast the component; and
(d) disposing at least a portion of the die within a vacuum chamber prior to the step of releasing the charge of material.

21. The method as recited in claim 20, wherein said step (b) includes the step of: selectively actuating a closure member between a first position and a second position to uncover the opening and release the charge of material through a bottom-most surface of the bottom portion.

22. The method as recited in claim 21, wherein said step (b) includes the step of: releasing the charge of material directly into one of the die and the shot tube of the die casting system.

23. A melting unit for a die casting system, comprising:
a top portion, a bottom portion and a body that extends between said top portion and said bottom portion;
an opening that extends through said bottom portion;
a closure member positioned relative to said opening and selectively moveable between a first position and a second position to uncover said opening and release a charge of material through said bottom portion and
a heating system having a first induction coil circumferentially disposed about said body and a second induction coil circumferentially disposed about said closure member.

24. (canceled)

25. (canceled)

26. The melting unit as recited in claim 23, wherein said heating system includes an induction skull melting system.

27. The melting unit as recited in claim 23, wherein said opening extends through a bottom-most surface of said bottom portion.

28. The system as recited in claim 1, wherein said charge of material is released through said bottom portion directly into said die.

29. The method as recited in claim 20, wherein the charge of material is released directly into the die.

30. The melting unit as recited in claim 23, comprising an actuator that moves said closure member between a first position and a second position, wherein each of said actuator and said closure member are cooled via a coolant source.
